(19) United States
(12) Patent Application Publication
(10) Pub. No.: US 2004/0025081 A1
(43) Pub. Date: Feb. 5, 2004

(54) System and method for collecting code coverage information before file system is available

(76) Inventors: Jorge Gonzalez, Ft. Collins, CO (US); Mark Hattarki, Ft. Worth, TX (US); Jeff Willy, Plano, TX (US); Dave Maison, Richardson, TX (US)

Correspondence Address: HEWLETT-PACKARD COMPANY, Intellectual Property Administration, P.O. Box 272400, Fort Collins, CO, 80527-2400, US

(21) Appl. No.: 10/209,794

(22) Filed: Jul. 31, 2002

(51) Int. Cl. H04L 1/22

(52) U.S. Cl. 714/25

(57) ABSTRACT

A system and method for collecting code coverage information in a computer environment before its file system is available. Upon powering up the computer system, initial and secondary system loaders are loaded, whereupon an OS kernel is brought into system memory. The boot process code of the OS kernel is exercised by a kernel exerciser operable to conduct a plurality of tests. Thereafter, a fatal error operable to crash the computer system is instigated and, pursuant thereto, a dump file is created in a dump process launched by the kernel. After rebooting the computer system, an extractor is utilized to recover the code coverage information relating to the boot process code from the dump file.

### CROSS-REFERENCE TO RELATED APPLICATION(S)

This application discloses subject matter related to the subject matter disclosed in the following commonly owned co-pending patent application(s): (i) “System And Method For Collecting Code Coverage Information On Fatal Error Path Code,” filed even date herewith, application No.: ______ (Docket Number 10018531-1), in the name(s) of: Jeff Willy, Mark Nathan Hattarki, David Leon Maison, and Jorge Gonzalez; and (ii) “System And Method For Testing Fatal Error Handling And Recovery Code Functionality In A Computer System,” filed Nov. 16, 2001, application Ser. No.: 09/991,318, in the name(s) of: Mark Nathan Hattarki and David Leon Maison.

### BACKGROUND OF THE INVENTION

1. Technical Field of the Invention

The present invention generally relates to computer systems. More particularly, and not by way of any limitation, the present invention is directed to a system and method for collecting code coverage information on boot process code of an operating system before the file system is available.

2. Description of Related Art

Code coverage analysis includes various structural and functional testing techniques which can be used to determine where additional testing is required with respect to a code portion. Structural testing technique (also sometimes referred to as “glass box” testing or “white box” testing) is used to uncover untested areas of code. Structural testing compares test program behavior against the apparent intention of the source code. This is in contrast to functional testing (referred to as “black box testing”), which compares test program behavior against a requirements specification. Structural testing is also called path testing since one can choose test cases that cause alternative paths to be taken through the structure of the program. Whereas structural testing examines how the program works, taking into account possible pitfalls in the structure and logic of the code, functional testing evaluates what the program accomplishes, without regard to how it works internally.

As a software testing technique, code coverage analysis is a powerful tool for exploring different parts of a lengthy computer program having extensive and complex internal structure such as, for example, an operating system (OS) kernel, to ensure that various modules of the program are structurally well-integrated. Not only is the coverage data useful in developing and evaluating defect-free software, but it can also be employed in verifying that a program's critical areas are adequately covered by the tests designed to exercise it. Relatedly, code coverage analysis is helpful in ascertaining that a minimum percentage of coverage of a program is met.

An important component of any OS is the functionality that is responsible for ensuring that boot-up process is executed efficiently and without errors. In general, upon successful completion of the boot-up, a file system and associated user space with appropriate login prompts are available for accepting user inputs/commands.

Various tests are available that can be performed on the kernel code before the system is booted all the way, i.e., before the file system is available. Whereas it is desirable that the kernel code should be vigorously tested even before the file system is available, preferably by both black box testing and white box testing techniques, obtaining coverage information regarding the relevant code portions, for example, the boot process code, has proved to be rather difficult. In general, collecting code coverage information requires two conditions. First, it is necessary that a file system be available for populating what are known as code coverage buffers with the appropriate coverage data. Second, a special utility tool is typically required to transfer the coverage information from memory to a file on disk. Unfortunately, neither of the these requirements can be met in the existing methodologies. Currently, when the tests are performed on kernel code portions before the file system is available, the computer system typically terminates the boot process and attempts to reboot. Upon rebooting, however, whatever code coverage data that has been collected will be lost or rendered unretrievable because the data cannot be transferred from memory to the file system.

### SUMMARY OF THE INVENTION

Accordingly, the present invention advantageously provides a system and method for collecting code coverage information in a computer environment before its file system is available. Upon powering up the computer system, initial and secondary system loaders are loaded into the system, whereupon an OS kernel is brought into system memory. The boot process code of the OS kernel is exercised by a kernel exerciser operable to conduct a plurality of tests. Thereafter, a fatal error operable to crash the computer system is instigated and, pursuant thereto, a dump file is created in a dump process launched by the kernel. After rebooting the computer system, an extractor is utilized to recover the code coverage information relating to the tested code portion (e.g., boot process code) from the dump file.

### BRIEF DESCRIPTION OF THE DRAWINGS

A more complete understanding of the present invention may be had by reference to the following Detailed Description when taken in conjunction with the accompanying drawings wherein:

FIG. 1 (Prior Art) depicts a flow chart of the steps involved in an exemplary conventional methodology pursuant to performing boot process tests in a computing environment before its file system is available;

FIG. 2 depicts a flow chart of the steps involved in the methodology for collecting code coverage information relating to the boot process code portion of an OS kernel in accordance with the teachings of the present invention; and

FIG. 3 a high level functional block diagram of an exemplary system of the present invention for collecting code coverage information relating to the boot process testing process.

### DETAILED DESCRIPTION OF THE DRAWINGS

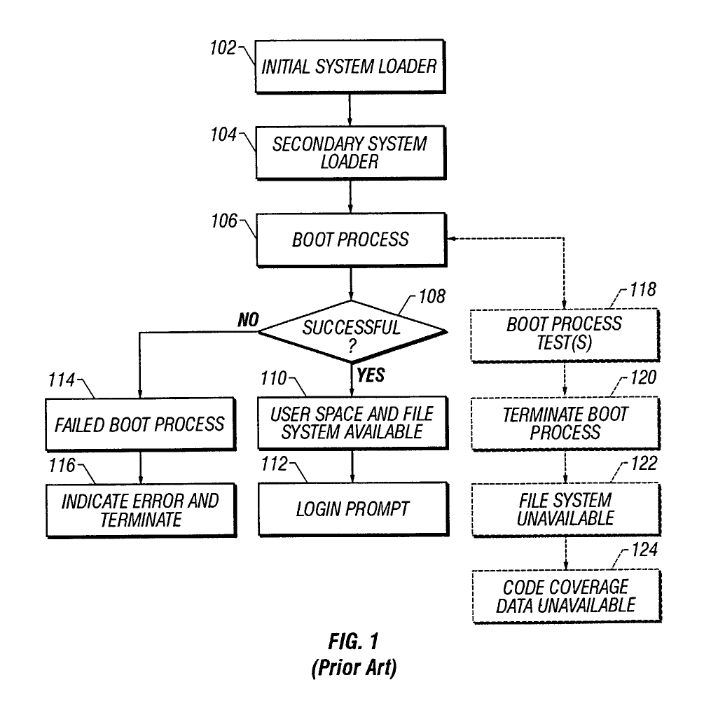

In the drawings, like or similar elements are designated with identical reference numerals throughout the several views thereof, and the various elements depicted are not necessarily drawn to scale. Referring now to FIG. 1, depicted therein is a flow chart of the steps involved in an exemplary conventional boot process methodology in a computing environment before its file system is available. Upon power up, an initial system loader (ISL) is loaded into the computer system pursuant to commencing the boot process (step 102). Thereafter, a secondary system loader (SSL) is loaded into the computer system (step 104). Responsive thereto, an OS kernel is brought into the computer system's memory and the boot process code of the kernel is then operable to be executed (step 106). In normal boot-up operation, upon determining that the boot process is successfully executed (decision block 108), a file system and associated user space are made available to the user (step 110). A login prompt is subsequently provided for accepting user inputs/commands (step 112).

If the boot process has not been successfully executed for whatever reason (decision block 108 and step 114) , an appropriate error reporting mechanism is employed to indicate the failed boot process and associated error diagnostics (step 116). The OS boot-up procedure may then be terminated in the indicated failed condition.

As set forth in the Background section of the present patent application, it is useful to exercise the boot process code of the OS kernel before the system is booted all the way, i.e., before the file system and associated user space are available. Typically, what is known as a kernel exerciser is employed, which may be specific to the particular software/hardware environment of the computing system. The kernel exerciser is operable to run one or more boot process tests (step 118). Upon completing the tests, the boot process is terminated before the system is booted all the way (step 120). Accordingly, the file system is unavailable thereafter (step 122). As a consequence, whatever code coverage information relating to the boot process that has been gathered in the code coverage (CC) buffers cannot be transferred to a file created under the file system. When the system is rebooted, therefore, the code coverage information is unavailable (step 124).

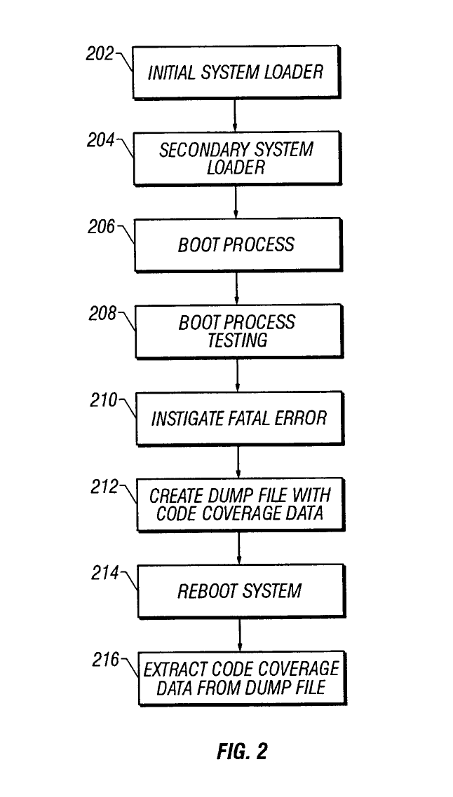

Referring now to FIG. 2, shown therein is a flow chart of the steps involved in an exemplary methodology in accordance with the teachings of the present invention for collecting code coverage information relating to the boot process code of an OS kernel before the file system is available. As before, upon powering up a computer system, an initial system loader is loaded into the computer system (step 202). A secondary system loader is loaded thereafter (step 204), whereupon the OS kernel is brought into the computer system's memory. Boot process code of the OS kernel is subsequently executed as part of booting the system (step 206). A suitable kernel exerciser is employed to exercise one or more code paths of the boot process code whose coverage is desired (step 208).

In accordance with the teachings of the present invention, a fatal error is then instigated which is operable to crash the system (step 210). The fatal error may be comprised of a software error (e.g., OS error), hardware error, or any other error. Responsive thereto, the OS invokes appropriate dump path code to gracefully shut down the system. A series of operations are taken by the OS pursuant to executing the dump path code in accordance with the teachings of the present invention. Preferably, the dump path code is operable such that a dump file having the code coverage data is created in the dump process (step 212), wherein a specified memory image including the CC data is copied to a “raw” dump device that does not need a file system. In one embodiment, the raw dump device can be a local disk drive that is specified by a device-specific hardware configuration path internal to the OS kernel. In other embodiments, the raw device can be any storage medium internally configurable by the OS via a hardware path during a dump process, provided the device is capable of persistent storage and has a fast transfer rate. The dump file created on the raw device includes the CC data, and once the system is rebooted (step 214), the dump file is copied into a file that exists under a file system created pursuant to the boot up. Accordingly, the functionality of the raw storage device relates to storing a specified memory image (including the CC data) before the memory image is scrubbed through power cycling. Thereafter, the CC data, which was included in the dump, can be extracted using an extractor (e.g., a debugging tool) and may be analyzed with a view to quantifying untested areas of code, if any (step 216).

It should be realized that in a further embodiment, the teachings set forth above may be implemented in a computer program product that is operable to collect code coverage information relating to a boot process code portion in a computer environment before its file system is available. The computer program product may preferably be embodied as a computer usable medium having computer readable program code thereon. Program code is provided for loading initial and secondary system loaders, which are operable to instantiate an OS kernel in the system memory. Program code is provided for exercising the boot process code of the kernel using one or more tests operable to cover various paths. Also included is program code operable to instigate a fatal error in the computer system, whereupon a dump file is preferably created on a local storage medium. Program code is provided for extracting, upon rebooting the computer system, the code coverage information relating to the boot process code from the stored dump file.

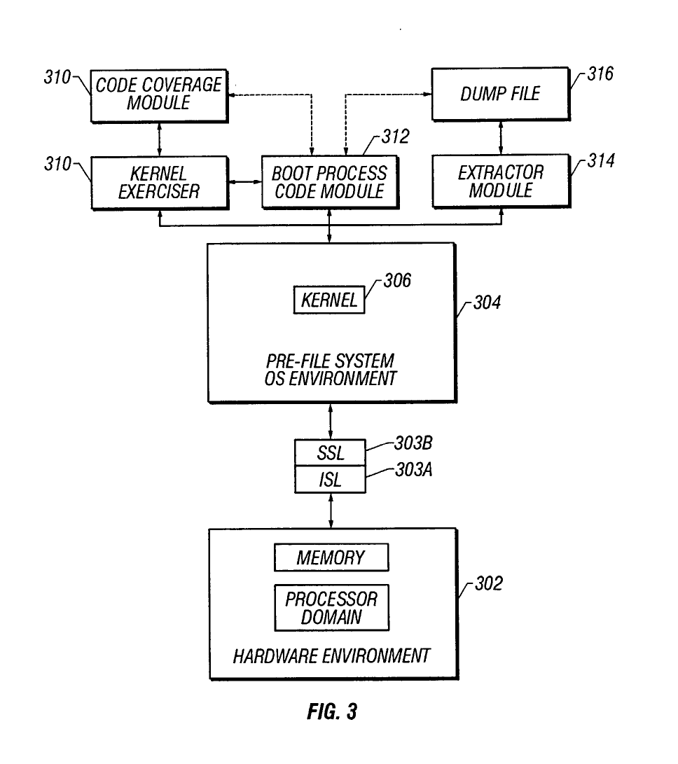

Referring now to FIG. 3, shown therein is a high level functional block diagram of an exemplary system of the present invention for collecting coverage information relating to the boot-up code testing process before the file system is available. Reference numeral 302 refers to the hardware environment of the computer system wherein the teachings of the present invention may be advantageously practiced. In a presently preferred exemplary embodiment of the present invention, the hardware of the computer system may be organized as a multicellular platform in a symmetrical multiprocessing (SMP) environment that supports the grouping of processor cells into one or more processor domains. A suitable OS environment 304 with kernel 306 is operable to run on the hardware upon the loading of the ISL module 303A and SSL module 303B. A pre-file system tester (e.g., a kernel exerciser) 310, whose coverage of the OS kernel's boot process code 312 is desired, operates in association with a code coverage module 308 for collecting various types of coverage information during the execution of the tester module. Also, an error/dump path code portion is provided as program code operable to be executed in association with, or as part of, the OS kernel, for generating a dump file 316 that includes the coverage data relating to the boot process code, which dump file is operable to be created on a hardware-path-specific raw device as set forth above. An extractor module 314 may be provided as separate program code (e.g., embodied as a computer program product) that can work in conjunction with commercially available coverage programs such as, e.g., C-Cover. As has been explained hereinabove, the extractor module 314 is operable to extract the necessary coverage information relating to the boot process code from the dump storage 316 that is created in accordance with the core dump process instigated after the boot testing is done.

Preferably, the code coverage module 310 is operable to provide various types of code coverage information relating to the selected boot process path code. Some of the exemplary coverage measures and their brief description are set forth immediately below:

Statement Coverage: Also known as line coverage, segment coverage, or basic block coverage, this measure reports whether each executable statement in the error path code is encountered.

Decision Coverage: This measure reports whether Boolean expressions tested in control structures (such as IF statement, WHILE statement, et cetera) evaluated to both TRUE and FALSE. The decision coverage measure is also referred to as branch coverage, all-edges coverage, or basis path coverage.

Condition Coverage: This measure reports the TRUE or FALSE outcome of each Boolean sub-expression, separated by LOGICAL-AND and LOGICAL-OR if they occur.

Path Coverage: This measure reports whether each of the possible paths in each function have been followed. Also known as predicate coverage, this measure views paths as possible combinations of logical conditions, wherein a path is defined to be a unique sequence of branches from the function entry to its exit/return.

Function Coverage: This measure tracks whether each function or procedure of the error path code is invoked during the execution of the test module.

Several other coverage measures such as call coverage, linear code sequence and jump (LCSAJ) coverage, data flow coverage, object code branch coverage, loop coverage, race coverage, weak mutation coverage, table coverage, etc. can also be included as part of the code coverage information gathered in accordance with the teachings of the present invention.

Various test modules may be employed for testing the boot process code functionality of the OS, and it may be desirable to obtain coverage information relating to each of the test modules. More generally, it should be realized that coverage information relating to any tests executed before the file system is available may be obtained in accordance with the teachings of the present invention. Furthermore, the dump files created upon completion of the pre-file system testing may comprise a full dump, partial dump, or a selective dump, etc. A full dump contains a copy of the entire system memory. A selective dump can be specified by selecting particular memory region(s) to copy. Exemplary selection criteria can be unused memory pages, kernel data structures, et cetera, and a selective dump may be done to simply verify that the feature of selecting the contents is operational. Either of these dump scenarios can be modified by further indicating the amount of storage space to be used for the dump files, whereby a partial dump may be effectuated as appropriate. Accordingly, a partial full dump or a partial selective dump may be implemented. Additionally, as pointed out before, several types of fatal errors (e.g., hardware errors, OS errors, etc.) can be instigated upon completion of the pre-file system testing for covering different code portions of the OS before the file system is up and running. Additional details relating to the instigation of fatal errors pursuant to executing a test module in an HP-UX® environment are provided in the following commonly owned co-pending patent application(s): (i) “System And Method For Testing Fatal Error Handling And Recovery Code Functionality In A Computer System,” filed Nov. 16, 2001, application Ser. No.: 09/991,318, in the name(s) of: Mark Nathan Hattarki and David Leon Maison, which is(are) hereby incorporated by reference.

It should be further appreciated by those skilled in the art upon having reference hereto that the hardware platform 302 may be comprised of any computer including, but not limited to, uniprocessor systems, multiprocessor (MP) systems such as symmetric and asymmetric MP systems, tightly-coupled or loosely-coupled MP systems, multicellular platforms wherein each cell comprises one or more processors, and the like. Similarly, the OS 304 may comprise any known and/or heretofore unknown operating systems such as Unix-based operating systems, e.g., HP-UX®, Solaris®, SunOS®, AIX® and Ultrix®; Windows®-based operating systems, e.g., Windows® 2000, NTO, etc.; MacOS®; Open VMS; and the like.

Based upon the foregoing Detailed Description, it should be apparent that the present invention provides an innovative system and method operable in a high performance computing environment for obtaining code coverage information relating to the testing of any pre-file system code path selectable by specifying one or more testing parameters. Quality of the testing modules can be not only assured but, where necessary, can also be significantly improved, as the untested portions of the selected pre-file system code portion (e.g., boot process code) can be uncovered and new tests and/or test flows can be developed to fill the coverage gaps. Since the test flows can be customized to suit different software and hardware configurations, coverage information can be reliably gathered in all types of computing environments.

It is believed that the operation and construction of the present invention will be apparent from the foregoing Detailed Description. While the system and method shown and described have been characterized as being preferred, it should be readily understood that various changes and modifications could be made therein without departing from the scope of the present invention as set forth in the following claims. For example, while the teachings of the present invention have been generally exemplified within the context of a hardware platform running the HP-UX® OS environment, e.g., an IA-64 platform, those skilled in the art should recognize that the present invention can be practiced in conjunction with other hardware and software platforms. Also, the fatal errors deliberately caused to create a system crash may comprise OS-based errors, hardware errors, or a combination thereof. Furthermore, the code coverage information in the dump files may be stored locally or remotely, using any known or heretofore unknown storage medium. Accordingly, all such modifications, extensions, variations, amendments, additions, deletions, combinations, and the like are deemed to be within the ambit of the present invention whose scope is defined solely by the claims set forth hereinbelow.

What is claimed is:

1. A method of collecting code coverage information in a computer system before its file system is available, comprising:
upon powering up said computer system, loading initial and secondary system loaders into said computer system, whereupon an operating system (OS) kernel is brought into said computer system's memory;
exercising a boot process code portion in said OS kernel using a kernel exerciser;
instigating a fatal error in said computer system, said fatal error operating to crash said computer system;
in response, creating a dump file in a dump process initiated by said kernel, said dump file including code coverage information relating to said boot process code portion; and
extracting said code coverage information from said dump file upon rebooting said computer system.

2. The method of collecting code coverage information as set forth in claim 1, wherein said fatal error comprises a hardware error.

3. The method of collecting code coverage information as set forth in claim 1, wherein said fatal error comprises an OS error.

4. The method of collecting code coverage information as set forth in claim 1, wherein said dump file comprises a full dump.

5. The method of collecting code coverage information as set forth in claim 1, wherein said dump file comprises a selective dump.

6. The method of collecting code coverage information as set forth in claim 1, wherein said dump file comprises a partial dump.

7. The method of collecting code coverage information as set forth in claim 1, wherein said select kernel exerciser is operable to conduct a plurality of tests on said boot process code portion of said OS kernel.

8. The method of collecting code coverage information as set forth in claim 1, wherein said OS kernel is comprised of a Unix-based OS kernel.

9. The method of collecting code coverage information as set forth in claim 1, wherein said dump file is created on a local storage medium.

10. The method of collecting code coverage information as set forth in claim 1, wherein said dump file is created on a storage medium configurable through a device-specific hardware path internal to the OS kernel.

11. The method of collecting code coverage information as set forth in claim 1, wherein said OS kernel is comprised of a Windows®-based OS kernel.

12. The method of collecting code coverage information as set forth in claim 1, wherein said step of extracting said code coverage information is performed using a debugging tool.

13. A system for collecting code coverage information in a computer system before its file system is available, comprising:
means for loading, upon powering up said computer system, initial and secondary system loaders into said computer system, whereupon an operating system (OS) kernel is brought into said computer system's memory;
a kernel exerciser operable to exercise a boot process code portion in said OS kernel;
means for instigating a fatal error in said computer system, said fatal error operating to crash said computer system;
means for creating, responsive to said fatal error, a dump file in a dump process initiated by said kernel, said dump file including code coverage information relating to said boot process code portion; and
an extractor operable to extract said code coverage information from said dump file upon rebooting said computer system.

14. The system for collecting code coverage information as set forth in claim 13, wherein said fatal error comprises a hardware error.

15. The system for collecting code coverage information as set forth in claim 13, wherein said fatal error comprises an OS error.

16. The system for collecting code coverage information as set forth in claim 13, wherein said dump file comprises a full dump.

17. The system for collecting code coverage information as set forth in claim 13, wherein said dump file comprises a selective dump.

18. The system for collecting code coverage information as set forth in claim 13, wherein said dump file comprises a partial dump.

19. The system for collecting code coverage information as set forth in claim 13, wherein said kernel exerciser is operable to conduct a plurality of tests on said boot process code portion of said OS kernel, said tests for selecting different paths through said boot process code portion.

20. The system for collecting code coverage information as set forth in claim 13, wherein said OS kernel is comprised of a Unix-based kernel.

21. The system for collecting code coverage information as set forth in claim 13, wherein said dump file is created on a local storage medium.

22. The system for collecting code coverage information as set forth in claim 13, wherein said dump file is created on a storage medium configurable through a device-specific hardware path internal to the OS kernel.

23. The system for collecting code coverage information as set forth in claim 13, wherein said OS kernel is comprised of a Windows®-based kernel.

24. The system for collecting code coverage information as set forth in claim 13, wherein said extractor comprises a debugging tool.

25. A computer program product operable to collect code coverage information relating to boot process code in a computer environment before its file system is available, said computer program product including a computer usable medium with computer readable program code thereon, comprising:
program code for loading initial and secondary system loaders into said computer environment, whereupon an operating system (OS) kernel is brought into said computer environment's memory;
program code for exercising a boot process code portion associated with said OS kernel;
program code operable to instigate a fatal error in said computer environment, said fatal error operating to crash said computer environment;
program code operable to create a dump file in a dump process initiated by said kernel, said dump file including code coverage information relating to said boot process code portion; and
program code operable to extract said code coverage information from said dump file upon rebooting said computer system.

26. The computer program product operable to collect code coverage information as set forth in claim 25, wherein said fatal error comprises a hardware error.

27. The computer program product operable to collect code coverage information as set forth in claim 25, wherein said fatal error comprises an OS error.

28. The computer program product operable to collect code coverage information as set forth in claim 25, wherein said dump file comprises a full dump.

29. The computer program product operable to collect code coverage information as set forth in claim 25, wherein said dump file comprises a selective dump.

30. The computer program product operable to collect code coverage information as set forth in claim 25, wherein said dump file comprises a partial dump.

31. The computer program product operable to collect code coverage information as set forth in claim 25, wherein said program code for exercising said boot process code portion is operable to conduct a plurality of tests relating to different paths associated with said boot process code portion.

32. The computer program product operable to collect code coverage information as set forth in claim 25, wherein said wherein said OS kernel is comprised of a Unix-based OS kernel.

33. The computer program product operable to collect code coverage information as set forth in claim 25, wherein said dump file is created on a local storage medium.

34. The computer program product operable to collect code coverage information as set forth in claim 25, wherein said dump file is created on a storage medium configurable through a device-specific hardware path internal to the OS kernel.

35. The computer program product operable to collect code coverage information as set forth in claim 25, wherein said OS kernel is comprised of a Windows®-based OS kernel.
